(19) United States
(12) Patent Application Publication
(10) Pub. No.: US 2011/0036643 A1
(43) Pub. Date: Feb. 17, 2011

(54) THERMALLY STABLE POLYCRYSTALLINE DIAMOND CONSTRUCTIONS

(76) Inventors: J. Daniel Belnap, Pleasant Grove, UT (US); Yi Fang, Provo, UT (US); Guojiang Fan, Salt Lake City, UT (US); Peter T. Cariveau, Draper, UT (US); Georgiy Voronin, Orem, UT (US); Yuelin Shen, Spring, TX (US); Youhe Zhang, Spring, TX (US); Feng Yu, Pleasant Grove, UT (US); Yahua Bao, Orem, UT (US); Ronald K. Eyre, Orem, UT (US)

Correspondence Address: SMITH INTERNATIONAL INC.;Patent Services, 1310 Rankin Rd., HOUSTON, TX, 77073, US

(21) Appl. No.: 12/852,421

(22) Filed: Aug. 6, 2010

Related U.S. Application Data
(60) Provisional application No. 61/250,816, filed on Oct. 12, 2009.
(60) Provisional application No. 61/232,228, filed on Aug. 7, 2009.

(51) Int. Cl. E21B 10/46; B24D 3/04; B24D 18/00; B01J 3/06

(52) U.S. Cl. 175/434; 428/161; 428/164; 428/323; 51/307; 51/295

(57) ABSTRACT

Thermally stable polycrystalline constructions comprise a diamond body joined with a substrate, and may have a nonplanar interface. The construction may include an interlayer interposed between the diamond body and substrate. The diamond body preferably has a thickness greater than about 1.5 mm, and comprises a matrix phase of bonded together diamond crystals and interstitial regions disposed therebetween that are substantially free of a catalyst material used to sinter the diamond body. A replacement material is disposed within the interstitial regions. A population of the interstitial regions may include non-solvent catalyst material and/or an infiltrant aid disposed therein. The diamond body comprises two regions; namely, a first region comprising diamond grains that may be sized smaller than diamond grains in a second region, and/or the first region may comprise a diamond volume that is greater than that in the second region.

### CROSS-REFERENCE TO RELATED APPLICATIONS

This application claims priority to U.S. Provisional Application No. 61/250,816, filed on Oct. 12, 2009, and claims priority to U.S. Provisional Application No. 61/232,228, filed on Aug. 7, 2009, both of which are hereby incorporated by reference in their entirety.

### FIELD OF THE INVENTION

This invention relates to thermally stable polycrystalline diamond constructions, and methods for forming the same, that are specially engineered to reduce cracking during formation and provide improved properties of thermal stability and delamination resistance during use when compared to conventional thermally stable polycrystalline diamond constructions.

### BACKGROUND OF THE INVENTION

The existence and use of polycrystalline diamond material types for forming tooling, cutting and/or wear elements is well known in the art. For example, polycrystalline diamond (PCD) is known to be used as cutting elements to remove metals, rock, plastic and a variety of composite materials. Such known polycrystalline diamond materials have a microstructure characterized by a polycrystalline diamond matrix first phase, that generally occupies the highest volume percent in the microstructure and that has the greatest hardness, and a plurality of interstitial second phases, that are generally filled with a solvent catalyst material used to facilitate the bonding together of diamond grains or crystals to form the polycrystalline matrix first phase during sintering.

PCD known in the art is formed by combining diamond grains (that will form the polycrystalline matrix first phase) with a suitable solvent catalyst material (that will form the second phase) to form a mixture. The solvent catalyst material may be provided in the form of powder and mixed with the diamond grains or may be infiltrated into the diamond grains during sintering. The diamond grains and solvent catalyst material are sintered at extremely high pressure-high temperature (HPHT) process conditions, during which time the solvent catalyst material promotes desired intercrystalline diamond-to-diamond bonding between the grains, thereby forming a PCD structure.

Solvent catalyst materials used for forming conventional PCD include Group VIII metals of the Periodic table, with cobalt (Co) being the most common. Conventional PCD may comprise from about 85 to 95% by volume diamond and a remaining amount being the solvent metal catalyst material. The solvent catalyst material is present in the microstructure of the PCD material within interstices or interstitial regions that exist between the bonded together diamond grains and/or along the surfaces of the diamond crystals.

The resulting PCD structure produces enhanced properties of wear resistance and hardness, making PCD materials extremely useful in aggressive wear and cutting applications where high levels of wear resistance and hardness are desired. Industries that utilize such PCD materials for cutting, e.g., in the form of a cutting element, include automotive, oil and gas, aerospace, nuclear and transportation to mention only a few.

For use in the oil production industry, such PCD cutting elements are provided in the form of specially designed cutting elements such as shear cutters that are configured for attachment with a subterranean drilling device, e.g., a shear or drag bit. Thus, such PCD shear cutters are used as the cutting elements in shear bits that drill holes in the earth for oil and gas exploration. Such shear cutters generally comprise a PCD body that is joined to a substrate, e.g., a substrate that is formed from cemented tungsten carbide. The shear cutter is manufactured using an HPHT process that generally utilizes cobalt as a catalytic second phase material that facilitates liquid-phase sintering between diamond particles to form a single interconnected polycrystalline matrix of diamond with cobalt dispersed throughout the matrix.

The shear cutter is attached to the shear bit via the substrate, usually by a braze material, leaving the PCD body exposed as a cutting element to shear rock as the shear bit rotates. High forces are generated at the PCD/rock interface to shear the rock away. In addition, high temperatures are generated at this cutting interface, which shorten the cutting life of the PCD cutting edge. High temperatures incurred during operation cause the cobalt in the diamond matrix to thermally expand. This thermal expansion is known to cause the diamond crystalline bonds within the microstructure to be broken at or near the cutting edge, thereby also operating to reduce the life of the PCD cutter. Also, in high temperature cutting environments, the cobalt in the PCD matrix can facilitate the conversion of diamond back to graphite, which is also known to radically decrease the performance life of the cutting element.

Attempts in the art to address the above-noted limitations have largely focused on the solvent catalyst material's degradation of the PCD construction by catalytic operation, and removal of the catalyst material therefrom for the purpose of enhancing the service life of PCD cutting elements. For example, it is known to treat the PCD body to remove the solvent catalyst material therefrom, which treatment has been shown to produce a resulting diamond body having enhanced cutting performance. One known way of doing this involves at least a two-stage technique of first forming a conventional sintered PCD body, by combining diamond grains and a solvent catalyst material and subjecting the same to HPHT process as described above, and then removing the solvent catalyst material therefrom, e.g., by acid leaching process.

The resulting diamond body that has been rendered free of the solvent catalyst material comprises essentially a matrix of diamond-bonded crystals with no other material occupying the interstitial regions between the diamond crystals. Such diamond body has improved properties of thermal stability when compared to conventional PCD, and as a result is referred to in the art as thermally stable polycrystalline diamond (TSP).

A difficulty known to exist with such TSP is the challenge associated with attaching the TSP body to a substrate to form a compact, thereby enabling attachment of the compact to a cutting and/or wear device by conventional technique, such as welding, brazing or the like. Without a substrate, the TSP body must be attached to the cutting and/or wear device by interference fit, which is not practical and does not provide a strong attachment to promote a long service life. Additionally, past attempts made to attach such TSP to a substrate by HPHT process has resulted in crack formation in the TSP and/or delamination between the substrate and TSP body during use, making it unsuited for use in a cutting and/or wear environment. Such crack formation is even more problematic when attempting to attach TSP to a substrate where the interface between the two is nonplanar.

It is, therefore, desirable that a thermally stable polycrystalline diamond construction be engineered in a manner that not only displays improved thermal characteristics, when compared to conventional PCD, but that is manufactured in a manner that reduces or eliminates crack formation during the step of attaching a TSP body to a desired substrate and that reduces or eliminates delamination during use, wherein the interface between the two may be planar or nonplanar.

### SUMMARY OF THE INVENTION

Thermally stable polycrystalline constructions comprise a diamond body joined with a substrate. The diamond body has a material microstructure comprising a matrix phase of bonded together diamond crystals formed at high pressure-high temperature conditions in the presence of a catalyst material, and interstitial regions disposed between the diamond crystals. The interstitial regions within the diamond body are substantially free of the catalyst material, and the diamond body comprises a replacement material disposed within the interstitial regions. In an example embodiment, the diamond body has a thickness of greater than about 1.5 mm, and preferably in the range of from about 1.5 to 2.5 mm, or from about 1.5 to 2 mm.

If desired, an interfacing surface between one or both of the diamond body and substrate may be nonplanar. An interlayer may be interposed between the diamond body and the substrate, wherein the interlayer comprises a constituent of the substrate and exists independently of the substrate. The interlayer may include diamond grains.

In an example embodiment the diamond body includes a non-solvent catalyst material disposed within the diamond body, wherein the non-solvent catalyst material is different from the replacement material, and may be selected from the group consisting of Si, Ti, Cu, low melting temperature materials and/or, alloys thereof. The diamond body may also include an infiltrant aid selected from the group of materials consisting of Fe, Cu, Ni, and combinations thereof.

The diamond body may comprise first and second regions, wherein the first region comprises diamond grains having a first average size, and having a first average diamond volume content. The second region comprises diamond grains having a second average size, and having a second average diamond volume content. The first average diamond grain size may be different, e.g., less than the second average diamond grain size, e.g., the first average size is in the range of from about 2 to 18 microns, and the second average size is in the range of from about 15 to 35 microns. The first average diamond volume content may be different, e.g., greater, than the second average diamond volume content, e.g., the first average diamond volume content is greater than about 90 percent, and the second average diamond volume content is greater than about 80 percent. In an example embodiment, the difference between the average volume content in the first and second regions is greater than about 1 percent.

The thermally stable diamond construction may be made by forming a polycrystalline diamond body at a high pressure-high temperature conditions in the presence of a catalyst material to form a matrix phase of bonded together diamond crystals. The catalyst material is removed from the polycrystalline diamond body to form a thermally stable diamond body. The thermally stable diamond body is placed adjacent a substrate, wherein the thermally stable diamond body and substrate are disposed within a pressure cell, wherein the pressure cell includes hexagonal boron nitride (hBN) surrounding exposed surfaces of the thermally stable diamond body. The pressure cell is subjected to high pressure-high temperature conditions to bond the thermally stable diamond body to the substrate.

The step of subjecting the pressure cell to high pressure-high temperature conditions may comprise first subjecting the cell to a first high pressure-high temperature condition in the diamond stable region to cause an infiltrant material to melt and infiltrate into the thermally stable diamond body, and then subjecting the pressure cell to a second high pressure-high temperature condition to cause the infiltrated the thermally stable diamond body to bond to the substrate. In an example embodiment, the second high pressure-high temperature condition is operated at a higher pressure than the first high pressure-high temperature condition.

Thermally stable polycrystalline diamond constructions according to embodiments herein are engineered to display improved thermal characteristics, when compared to conventional PCD. Further, such thermally stable polycrystalline diamond constructions are manufactured in a manner that reduces or eliminates crack formation during the step of attaching a TSP body to a desired substrate, and that reduces or eliminates delamination during use, wherein the interface between the two may be planar or nonplanar.

In one embodiment, a polycrystalline diamond construction includes a diamond body having a material microstructure comprising a matrix phase of bonded together diamond crystals formed at high pressure-high temperature conditions in the presence of a catalyst material, and interstitial regions disposed between the diamond crystals. The interstitial regions within the diamond body are substantially free of the catalyst material, and the diamond body comprises a replacement material disposed within the interstitial regions. The diamond body has a thickness greater than about 1.5 mm. The polycrystalline diamond construction also includes a substrate joined with the diamond body. The diamond body and substrate include interfacing surfaces with nonplanar surface features that complement one another, and the substrate is in direct contact with the diamond body. In one embodiment, a bit for drilling subterranean formations is provided, including a body and a number of cutting elements attached to the body, and the cutting elements comprise the polycrystalline diamond construction just described.

In one embodiment, a polycrystalline diamond construction includes a diamond body having a material microstructure comprising a matrix phase of bonded together diamond crystals formed at high pressure-high temperature conditions in the presence of a catalyst material, and interstitial regions disposed between the diamond crystals. The interstitial regions within the diamond body are substantially free of the catalyst material, and the diamond body includes a replacement material disposed within the interstitial regions. The diamond body includes a first region with diamond grains having a first average size, and having a first average diamond volume content, and a second region with diamond grains having a second average size, and having a second average diamond volume content. The first average diamond volume content is different from the second average diamond volume content. The polycrystalline diamond construction also includes a substrate joined with the diamond body.

In one embodiment, a polycrystalline diamond construction includes a diamond body having a material microstructure having a matrix phase of bonded together diamond crystals and interstitial regions disposed between the diamond crystals. The diamond body includes a first diamond region and a second diamond region. The matrix phase of bonded together diamond crystals in the first diamond region are formed during a first high pressure-high temperature process, and the first diamond region is substantially free of a catalyst material used during the first high pressure-high temperature process. The matrix phase of bonded together diamond crystals in the second diamond region are formed during a second high pressure-high temperature process, and the second diamond region includes a catalyst material used during the second high pressure-high temperature process. A substrate is joined with the diamond body. In one embodiment, a bit for drilling subterranean formations is provided, including a body and a number of cutting elements attached to the body, wherein the cutting elements comprise the construction just described.

In one embodiment, a method of making a thermally stable diamond construction includes forming a polycrystalline diamond body at high pressure-high temperature conditions in the presence of a catalyst material to form a matrix phase of bonded together diamond crystals, removing the catalyst material from the polycrystalline diamond body to form a thermally stable diamond body, and placing the thermally stable diamond body adjacent a substrate. The thermally stable diamond body and substrate are disposed within a pressure cell, and the pressure cell includes hBN surrounding exposed surfaces of the thermally stable diamond body. The method also includes subjecting the pressure cell to high pressure-high temperature conditions to bond the thermally stable diamond body to the substrate.

In one embodiment, a method of making a thermally stable diamond construction includes forming a polycrystalline diamond body at high pressure-high temperature conditions in the presence of a catalyst material to form a matrix phase of bonded together diamond crystals, removing the catalyst material from the polycrystalline diamond body to form a thermally stable diamond body, and placing the thermally stable diamond body adjacent a substrate. The thermally stable diamond body and substrate are disposed within a pressure cell. The method also includes subjecting the pressure cell to a first high pressure-high temperature condition in the diamond stable region to cause an infiltrant material to melt and infiltrate into the thermally stable diamond body, and subjecting the pressure cell to a second high pressure-high temperature condition to cause the infiltrated thermally stable diamond body to bond to the substrate. The second high pressure-high temperature condition is operated at a higher pressure than the first high pressure-high temperature condition.

In one embodiment, a method of making a thermally stable diamond construction includes forming a first polycrystalline diamond body at high pressure-high temperature conditions in the presence of a catalyst material to form a matrix phase of bonded together diamond crystals, removing the catalyst material from the first polycrystalline diamond body to form a thermally stable diamond body, placing the thermally stable diamond body adjacent a polycrystalline diamond compact comprising a second polycrystalline diamond body attached to a substrate to form an assembly, and subjecting the assembly to a high pressure-high temperature condition to bond the thermally stable diamond body to the compact.

### BRIEF DESCRIPTION OF THE DRAWINGS

These and other features and advantages of the present invention will be appreciated as the same becomes better understood by reference to the following detailed description when considered in connection with the accompanying drawings wherein:

FIG. 1A is a schematic view of a region taken from a thermally stable polycrystalline diamond body having a material microstructure comprising a plurality of empty interstitial regions disposed between bonded-together diamond crystals;

FIG. 1B is a schematic view of a region taken from a thermally stable polycrystalline diamond body having a material microstructure wherein the plurality of the interstitial regions are filled with an infiltrant material;

FIGS. 2A and 2B are cross-sectional schematic side views of polycrystalline diamond constructions according to embodiments of the present disclosure during different stages of formation;

FIG. 3 is a cross-sectional schematic side view illustrating an embodiment of a polycrystalline diamond body, useful for making thermally stable polycrystalline diamond constructions, comprising two different diamond layers;

FIG. 4 is a cross-sectional schematic side view illustrating an embodiment of a thermally stable polycrystalline diamond body comprising an infiltrant material;

FIG. 5 is a cross-sectional schematic side view illustrating an embodiment of a thermally stable polycrystalline diamond compact construction comprising a thermally stable polycrystalline diamond body attached to a substrate;

FIG. 6 is a cross-sectional schematic side view illustrating an embodiment of a thermally stable polycrystalline diamond compact construction comprising a diamond body having a thermally stable polycrystalline diamond region and a polycrystalline diamond region attached to a substrate;

FIG. 7 is a perspective side view of an insert, for use in a roller cone or a hammer drill bit, comprising a thermally stable polycrystalline diamond construction;

FIG. 8 is a perspective side view of a roller cone drill bit comprising a number of the inserts of FIG. 7;

FIG. 9 is a perspective side view of a percussion or hammer bit comprising a number of the inserts of FIG. 7;

FIG. 10 is a schematic perspective side view of a diamond shear cutter comprising a thermally stable polycrystalline diamond construction;

FIG. 11 is a perspective side view of a drag bit comprising a number of the shear cutters of FIG. 10; and

FIG. 12 is a cross-sectional view of an assembly for bonding according to an embodiment of the present disclosure.

### DETAILED DESCRIPTION

Thermally stable polycrystalline diamond (TSP) constructions have a material microstructure comprising a polycrystalline matrix first phase formed from bonded-together diamond grains or crystals. The diamond body further includes interstitial regions disposed between the bonded-together diamond crystals that are substantially free of the catalyst material that was used to initially sinter the diamond body.

The diamond body may include one or more types of replacement or infiltrant material disposed within a population of the interstitial regions. The infiltrant material may occupy one or more regions within the diamond body, and the source of the infiltrant material may be a substrate attached to the diamond body and/or be a material provided separately from the substrate. The diamond body may have a layered construction comprising differently sized and/or packed diamond grains at different body regions to provide desired properties of wear resistance and/or to facilitate infiltration of a desired replacement or infiltrant.

The construction additionally comprises a substrate that is attached to the diamond body, thereby forming a compact construction. The construction is made in a manner that is specifically engineered to provide a desired degree of thermal stability, while at the same time providing an enhanced degree of crack resistance during formation, and an enhanced degree of attachment strength between the diamond body and substrate so as to resist delamination during use when subjected to a wear and/or cutting application. The presence of a substrate in such compact constructions operates to facilitate attachment of the construction to desired tooling, cutting, machining, and/or wear devices, e.g., a drill bit used for drilling subterranean formations.

As used herein, the term “thermally stable polycrystalline diamond” (TSP) refers to a material that has been formed at high pressure-high temperature (HPHT) conditions that has a material microstructure comprising a matrix phase of bonded-together diamond crystals and that includes a plurality or second phases in the form of interstitial regions that are substantially free of the catalyst material that was used to initially form/sinter the matrix diamond phase. TSP constructions according to embodiments of this disclosure may be formed by subjecting precursor diamond grains or powder to HPHT sintering conditions in the presence of a catalyst material, e.g., a solvent metal catalyst, that functions to facilitate the bonding together of the diamond grains at temperatures of between about 1,350 to 1,500° C., and at pressures of about 5,000 Mpa or higher. Suitable catalyst materials useful for making such polycrystalline diamond (PCD) include those metals identified in Group VIII of the Periodic table (CAS version of the periodic table in the CRC Handbook of Chemistry and Physics), such as cobalt.

As used herein, the terms “thermally stable” and “thermal stability” are understood to refer to characteristics of the diamond body that include but are not limited to relative thermal compatibilities such as thermal expansion properties, of the materials occupying the different construction material phases, and the absence of materials within the diamond body that may operate to cause an unwanted transformation of the diamond crystals in the matrix phase during cutting and/or wear applications and operating temperatures that may adversely impact performance and service life.

A feature of TSP constructions is that they comprise a diamond body that retains the matrix phase of bonded-together diamond crystals, but the body has been modified so that it no longer includes the catalyst material used during the sintering process to initially form the diamond body that exists in conventional PCD. Rather, the diamond body has been specially treated so that such catalyst material is substantially removed from the interstitial regions.

A further feature of TSP constructions is that they may include a replacement or infiltrant material that is introduced after the solvent metal catalyst used to form the diamond body has been removed therefrom, wherein the presence of such infiltrant material may operate to enhance the attachment strength between the body and a substrate, and/or to improve one or more property of the diamond body, such as toughness and/or strength and/or thermal stability, when compared to conventional TSP bodies that lack the presence of such infiltrant material.

As used herein, the term “infiltrant material” is understood to refer a material that is not the catalyst material that was used to initially form/sinter the diamond body, and may include materials identified in Group VIII of the Periodic table that have subsequently been introduced into the sintered diamond body after the catalyst material used to form the same has been removed therefrom. Additionally, the term “infiltrant material” is not intended to be limiting on the particular method or technique used to introduce such material into the already formed diamond body.

A still further feature of TSP constructions is that they are made in a manner specifically engineered to reduce and/or eliminate the unwanted creation of cracks in the TSP body during the step of attaching the TSP body to a desired substrate at HPHT conditions, for constructions comprising either a planar or nonplanar TSP body-to-substrate interface.

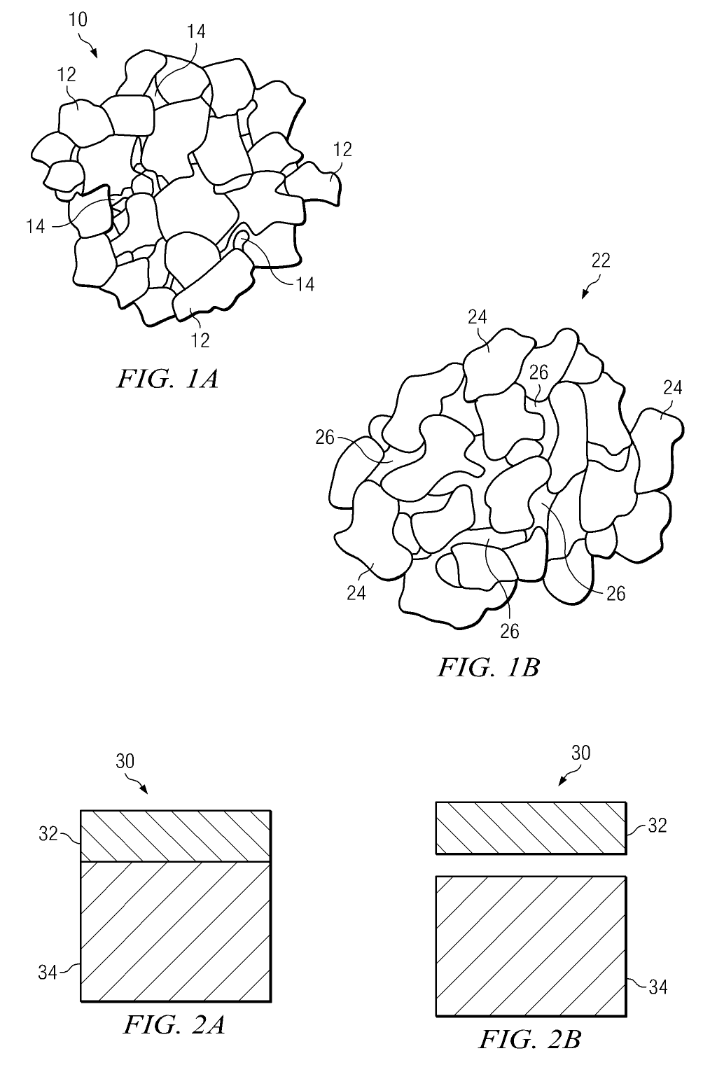

FIG. 1A schematically illustrates a region 10 of a TSP body used for making TSP constructions. This region 10 of the TSP body has a material microstructure comprising a plurality of bonded-together diamond crystals 12, forming an intercrystalline diamond matrix first phase, and a plurality of second regions 14 that are disposed interstitially between the diamond crystals and that are substantially free of the catalyst material that was used to initially form/sinter the diamond body by HPHT process.

FIG. 1B schematically illustrates a region 22 of a TSP body used for making TSP constructions at a time after the TSP body has been attached to a desired substrate, e.g., by HPHT process and/or reinfiltration with a desired infiltrant or binding aid. This region 22 of the TSP body has a material microstructure that comprises the plurality of bonded together diamond crystals 24, forming the intercrystalline diamond matrix first phase. The material microstructure also includes the plurality of second phases disposed interstitially between the diamond crystals and that are now filled with an infiltrant material 26. For purposes of clarity, it is understood that the region 22 of the TSP body is one taken after the TSP body has been treated to remove the catalyst material used to initially sinter the diamond body, and after a population of the interstitial regions have been filled with a desired infiltrant material.

The region 22 illustrated in FIG. 1B is provided for the purpose of referencing the presence of an infiltrant disposed within the TSP body. This region may be located within the TSP body at a variety of different positions. In an example embodiment, the region including the infiltrant may be positioned adjacent the substrate. If desired, the region including the infiltrant may be positioned at other locations within the body, e.g., along a working surface that may be a top and/or edge and/or side surface(s) of the body. The infiltrant occupying one position in the TSP body may be the same or different from an infiltrant occupying another position within the body.

In an example embodiment, the TSP construction may comprise a TSP body having a material microstructure comprising a matrix phase of bonded-together diamond grains and a plurality of interstitial regions dispersed within the matrix phase and substantially free of the catalyst material used to initially sinter the diamond body, wherein the body includes a first region with interstitial regions that are substantially empty, and a second region with interstitial regions that include an infiltrant material. Alternatively, the TSP body may comprise a microstructure where a significant population of the interstitial regions is filled with one or more infiltrant materials.

FIGS. 2A and 2B each schematically illustrate an exemplary TSP construction 30 at different stages of formation, according to an embodiment of the present disclosure. FIG. 2A illustrates a first stage of formation, starting with a conventional PCD body 32 in its initial form after sintering by a conventional HPHT sintering process. At this early stage, the PCD body 32 comprises a polycrystalline diamond matrix phase and a solvent catalyst metal material, such as cobalt, used to form the diamond matrix phase and that is disposed within the interstitial regions between the bonded-together diamond crystals.

The solvent catalyst metal material may be added to the precursor diamond grains or powder as a raw material powder prior to HPHT sintering, it may be contained within the diamond grains or powder, or it may be infiltrated into the diamond grains or powder during the sintering process from a substrate that contains the solvent metal catalyst material and that is placed adjacent the diamond powder and exposed to the HPHT sintering conditions. In an example embodiment, the solvent metal catalyst material is provided as an infiltrant from a substrate 34, e.g., a WC-Co substrate, during the HPHT sintering process.

Diamond grains useful for forming the PCD body include synthetic or natural diamond powders having an average diameter grain size in the range of from submicrometer in size to 100 micrometers, and more preferably in the range of from about 1 to 80 micrometers. The diamond powder may contain grains having a mono or multi-modal size distribution. In the event that diamond powders are used having differently sized grains, the diamond grains are mixed together by conventional process, such as by ball or attrittor milling for as much time as necessary to ensure good uniform distribution.

FIG. 2B schematically illustrates an exemplary TSP construction 30 after a second stage of formation, specifically at a stage where the solvent catalyst material used to initially form the diamond body and disposed in the interstitial regions and/or attached to the surface of the bonded together diamond crystals has been removed from the diamond body 32. At this stage of making the construction, the diamond body has a material microstructure resembling region 22 that is illustrated in FIG. 1A, comprising the diamond matrix phase formed from a plurality of bonded together diamond crystals 12, and interstitial regions 14 that are substantially free of the specific catalyzing material, e.g., cobalt, that was used during the sintering process to initially form the body of bonded diamonds and that remained from that sintering process used to initially form the diamond matrix phase.

As used herein, the term “removed” is used to refer to the reduced presence of the specific catalyst material in the diamond body that was used to initially form the diamond body during the sintering or HPHT process, and is understood to mean that a substantial portion of the catalyst material no longer resides within the diamond body. However, it is to be understood that some small trace amounts of the catalyst material may still remain in the microstructure of the diamond body within the interstitial regions and/or adhered to the surface of the diamond crystals. Additionally, the term “substantially free”, as used herein to refer to the remaining diamond body after the specific catalyst material used to form it during sintering has been removed, is understood to mean that there may still be some trace small amounts of the specific metal catalyst remaining within the diamond body as noted above. By “substantially free” of added catalyst material, it is understood to mean that no catalyst material, other than catalyst material left as an impurity from manufacturing the diamond crystals, is added to the diamond mixture. That is, the term “substantially free”, as used herein, is understood to mean that a specific material is removed, but that there may still be some small amounts of the specific material remaining within interstitial regions of the PCD body. In an example embodiment, the PCD body may be treated such that more than 98% by weight (% w of the treated region) has had the catalyst material removed from the interstitial regions within the treated region, in particular at least 99% w, more in particular at least 99.5% w may have had the catalyst material removed from the interstitial regions within the treated region. One to two % w metal may remain, most of which is trapped in regions of diamond regrowth (diamond-to-diamond bonding) and is not necessarily removable by chemical leaching.

The quantity of the specific catalyst material used to form the diamond body remaining in the material microstructure after the diamond body has been subjected to treatment to remove the same can and will vary based on such factors such as the efficiency of the removal process, and the size and density of the diamond matrix material. In an example embodiment, the catalyst material used to form the diamond body is removed therefrom by a suitable process, such as by chemical treatment such as by acid leaching or aqua regia bath, electrochemically such as by electrolytic process, by liquid metal solubility technique, by liquid metal infiltration technique that sweeps the existing second phase material away and replaces it with another during a liquid-phase sintering process, or by combinations thereof. In an example embodiment, the catalyst material is removed from all or a desired region of the PCD body by an acid leaching technique, such as that disclosed for example in U.S. Pat. No. 4,224,380, which is incorporated herein by reference.

Accelerating techniques for removing the catalyst material may also be used, and may be used in conjunction with the leaching techniques noted above as well as with other conventional leaching processing. Such accelerating techniques include elevated pressures, elevated temperatures and/or ultrasonic energy, and may be useful to decrease the amount of treatment time associated with achieving the same level of catalyst removal, thereby improving manufacturing efficiency.

Referring again to FIG. 2B, at this stage of the process any substrate 34 that was used as a source of the catalyst material may be removed from the diamond body 32, and/or may fall away from the diamond body during the process of catalyst material removal. In an example embodiment, it may be desired to remove the substrate from the diamond body before the process of catalyst removal, to facilitate the catalyst removal process, e.g., so that all surfaces of the diamond body may be exposed for the purpose of catalyst material removal. If the catalyst material was mixed with or otherwise provided with the precursor diamond powder, then the TSP construction 30 at this stage of manufacturing may not contain a substrate, i.e., it may only consist of a diamond body 32.

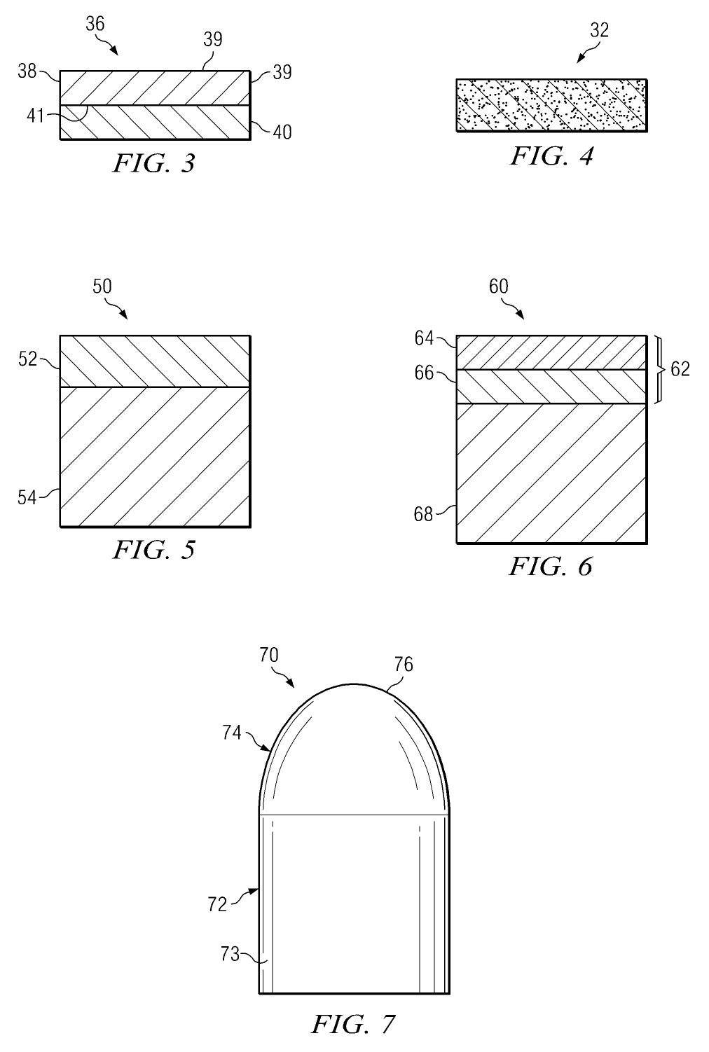

FIG. 3 illustrates an example embodiment of a PCD body 36, useful for making TSP constructions, formed during HPHT processing and having a multilayer construction. In an example embodiment, the diamond body 36 has a two-layer construction, comprising a first layer 38 and a second layer 40. The first and second layers may be formed from the same or differently sized diamond grains, and/or having a volume content of diamond that is the same or different. In an example embodiment, the first and second layers have a different diamond volume content, e.g., characterized by a difference of at least about 1 percent. The difference in diamond volume content may exist alone or in addition to a difference in diamond grain size between the first and second regions.

In an example embodiment, the first layer 38 is formed from relatively fine-sized diamond grains that are closely packed together, and a second layer 40 is formed from relatively coarse-sized diamond grains that are loosely packed together. In an example embodiment, the first diamond layer 38 is positioned along what will be a working surface 39 of the diamond body, and the second layer 40 is positioned along what will be an interface surface 41 with a desired substrate.

While a multilayer diamond body comprising two layers has been disclosed and illustrated, it is to be understood that diamond bodies comprising more than two layers having different diamond grain sizes and/or diamond volume contents may be used to form TSP constructions, and are thus intended to be within the scope of this disclosure. In an example embodiment it is helpful that the TSP body have a greater open pore volume in a region that is adjacent the substrate to facilitate bonding between the body and substrate and/or to facilitate infiltration from the substrate. This feature of relatively high pore volume or different pore volume within the TSP body adjacent the substrate may exist with or without differences in diamond grains size and/or differences in diamond density.

Forming a PCD body having such a multilayer construction, with the relatively loosely packed coarse-sized diamond grains positioned at the substrate interface, is desired because it operates to facilitate desired infiltration of an infiltrant from the substrate into the diamond body during HPHT processing. Additionally, placement of the relatively fine-sized diamond grains at the working surface of the diamond body operates to provide improved toughness and wear resistance where it is most needed, i.e., at or adjacent the working surface, when the resulting TSP construction is placed into a wear and/or cutting operation.

In such a multilayer diamond body embodiment, the relatively fine-sized diamond grains may have an average grain size of less then about 20 micrometers, preferably in the range of from about 2 to 18 micrometers, and more preferably in the range of from about 4 to 14 micrometers, with the most preferred having an average diamond grain size of 6 to 12 micrometers. The relatively coarse-sized diamond grains may have an average grain size of greater than about 10 microns, preferably in the range of from about 15 to 35 micrometers, and more preferably in the range of from about 22 to 28 micrometers, with the most preferred having an average diamond grain size of approximately 25 micrometers. As noted above, in such multilayer diamond body embodiments, it is desired that there be a difference in the diamond volume content of at least about 1 percent between the layers.

In such a multilayer diamond body embodiment, the volume content of the fine-sized diamond grains used to form the first layer may be in the range of from about 85 to 98 percent of the layer, and preferably greater than 90 percent in the range of from about 90 to 96 percent, and more preferably 94 to 95 percent. In such multilayer diamond body, the volume content of the coarse-sized diamond grains used to form the second layer may be greater than 80 percent of the layer, in the range of from about 80 to 92 percent, and preferably in the range of from about 85 to 90 percent, and more preferably approximately 87 to 88 percent.

In such multilayer diamond body embodiment, the first layer has a minimum thickness of about 0.5 mm, and the second layer has a minimum thickness of about 1.0 mm. It is to be understood that the exact thickness of the layers within the multilayer diamond body may vary depending on the diamond body diameter.

The multilayer diamond body may be provided in powder form by stacking one volume of diamond powder, e.g., comprising the desired fine-sized diamond grains, on top of another volume of diamond powder, e.g., comprising the desired coarse-sized diamond grains, and then subjecting the diamond grains to HPHT processing. Alternatively, the different layers of the diamond may be provided in green-state form, e.g., in the form of different diamond tapes or the like having the different desired diamond grain sizes and/or densities, which tape assembly is then subjected to HPHT processing. Alternatively, the different layers of the diamond may be provided in the form of sintered bodies each having the desired diamond grain size and/or volume content, which bodies may be joined together during a subsequent HPHT process, which may be the same or different from one used to attached a substrate to the TSP body.

In the event that the multilayer diamond body is formed by combining two or more sintered diamond bodies, the interface between the two adjacent diamond bodies may be planar or nonplanar. In an example embodiment, an improved degree of attachment strength and/or resistance to delamination during use may be realized when the adjacent surfaces of the diamond bodies are nonplanar and complement one another. That is, the surfaces may be nonplanar with one surface being the reverse of the other so that they mate when placed adjacent each other. The nonplanar configuration may be axially symmetric or asymmetric.

As noted above, the diamond powder may be combined with a desired solvent metal catalyst powder to facilitate diamond bonding during the HPHT process and/or the solvent metal catalyst may be provided by infiltration from a substrate positioned adjacent the diamond powder during the HPHT process. Suitable solvent metal catalyst materials useful for forming the PCD body include those metals selected from Group VIII of the Periodic table. A particularly preferred solvent metal catalyst is cobalt (Co).

Alternatively, the diamond powder mixture may be provided in the form of a green-state part or mixture comprising diamond powder that is contained by a binding agent, e.g., in the form of diamond tape or other formable/conformable diamond mixture product to facilitate the manufacturing process. In the event that the diamond powder is provided in the form of such a green-state part it is desirable that a preheating step take place before HPHT consolidation and sintering to drive off the binder material. In an example embodiment, the PCD body resulting from the above-described HPHT process may have a diamond volume content in the range of from about 85 to 95 percent. For certain applications, a higher diamond volume content up to about 98 percent may be desired.

The diamond powder or green-state part is loaded into a desired container for placement within a suitable HPHT consolidation and sintering device. In an example embodiment, where the source of the solvent metal catalyst material is provided by infiltration from a substrate, a suitable substrate material is disposed within the consolidation and sintering device adjacent the diamond powder mixture. In a preferred embodiment, the substrate is provided in a preformed state.

Substrates useful for forming the PCD body may be selected from the same general types of materials conventionally used to form substrates for conventional PCD materials, including carbides, nitrides, carbonitrides, ceramic materials, metallic materials, cermet materials, and mixtures thereof. A feature of the substrate used for forming the PCD body is that it includes a solvent metal catalyst capable of melting and moving into the adjacent volume of diamond powder to facilitate conventional diamond-to-diamond intercrystalline bonding forming the PCD body. A preferred substrate material is cemented tungsten carbide (WC-Co).

Where the solvent metal catalyst is provided by infiltration from a substrate, the container including the diamond power and the substrate is loaded into the HPHT device and the device is then activated to subject the container to a desired HPHT condition to effect consolidation and sintering of the diamond powder. In an example embodiment, the device is controlled so that the container is subjected to a HPHT process having a pressure of 5,000 Mpa or more and a temperature of from about 1,350° C. to 1,500° C. for a predetermined period of time. At this pressure and temperature, the solvent metal catalyst melts and infiltrates into the diamond powder, and the diamond grains are sintered to form conventional PCD.

While a particular pressure and temperature range for this HPHT process has been provided, it is to be understood that such processing conditions may and will vary depending on such factors as the type and/or amount of solvent metal catalyst used in the substrate, as well as the type and/or amount of diamond powder used to form the PCD body or region. After the HPHT sintering process is completed, the container is removed from the HPHT device, and the assembly comprising the bonded together PCD body and substrate is removed from the container. Again, it is to be understood that the PCD body may be formed without using a substrate if so desired.

As mentioned above, the catalyst material may be removed from the PCD body to form a TSP body with substantially empty voids between the bonded diamond crystals. Replacement or infiltrant materials useful for filling empty voids in the TSP body may be selected from the group of materials including metals, ceramics, cermets, and combinations thereof. In an example embodiment, the infiltrant material is a metal or metal alloy selected from Group VIII of the Periodic table, such as cobalt, nickel, iron or combinations thereof. It is to be understood that the choice of material or materials used as the infiltrant material may and will vary depending on such factors including but not limited to the end-use application, and the type and density of the diamond grains used to form the polycrystalline diamond matrix first phase, and the mechanical properties and/or thermal characteristics desired for the TSP construction.

Once the catalyst material used to initially form the diamond body is removed from the diamond body, the remaining microstructure comprises a polycrystalline matrix phase with a plurality of interstitial voids forming what is essentially a porous material microstructure. This porous microstructure not only lacks mechanical strength, but also lacks a material constituent that is capable of forming a strong attachment bond with a substrate, e.g., in the event that the TSP construction needs to be in the form of a compact comprising such a substrate to facilitate attachment to an end-use device.

The voids or pores in the TSP diamond body may be filled with the infiltrant material using a number of different techniques. Further, all of the voids or only a portion of the voids in the diamond body may be filled with the replacement material. In an example embodiment, the infiltrant material may be introduced into the diamond body by liquid-phase sintering under HPHT conditions. In such example embodiment, the infiltrant material may be provided in the form of a sintered part or a green-state part that contains the infiltrant material and that is positioned adjacent one or more surfaces of the TSP diamond body. The assembly is placed into a container that is subjected to HPHT conditions sufficient to melt the infiltrant material within the sintered part or green-state part and cause it to infiltrate into the diamond body. In an example embodiment, the source of the infiltrant material may be a substrate that will be used to form the TSP construction, by attachment of the substrate to the diamond body during the HPHT process.

Alternatively, rather than using the compact substrate as a source of the infiltrant material, the source of the replacement material or infiltrant may be a powder or solid-form article, e.g., a foil or the like, positioned adjacent the diamond body and subjected to HPHT processing. Suitable powders or solid-form articles include those selected from the group of replacement or infiltrant materials noted above.

The term “filled”, as used herein to refer to the presence of the infiltrant material in the voids or pores of the diamond body that resulted from removing the catalyst material used to form the diamond body therefrom, is understood to mean that a substantial volume of such voids or pores contain the infiltrant material. However, it is to be understood that there may also be a volume of voids or pores within the same region of the diamond body that do not contain the infiltrant material, and that the extent to which the infiltrant material effectively displaces the empty voids or pores will depend on such factors as the particular microstructure of the diamond body, the effectiveness of the process used for introducing the infiltrant material, and the desired mechanical and/or thermal properties of the resulting TSP construction.

The diamond body may be treated so that the infiltrant occupies the entire diamond body, or only occupies a partial region of the diamond body, depending on the particular construction embodiment. In a preferred embodiment, the infiltrant substantially fills all of the voids or pores within the diamond body. In some embodiments, complete migration of the infiltrant material through the diamond body may not be realized, in which case a region of the diamond body may not include the infiltrant material. This region devoid of the infiltrant material from such incomplete migration may extend from the region comprising the infiltrant to a surface portion of the diamond body.

In an example embodiment, a substrate is used as the source of the infiltrant material and to form the TSP construction. Substrates useful in this regard may include substrates that are used to form conventional PCD, e.g., those formed from metals, ceramics, and/or cermet materials that contain a desired infiltrant. In an example embodiment, the substrate is formed from WC-Co, and is positioned adjacent the diamond body after the metal catalyst material used to initially form the same been removed, and the assembly is subjected to HPHT conditions sufficient to cause the cobalt in the substrate to melt and infiltrate into and fill the voids or pores in the polycrystalline diamond matrix.

The substrate used as a source for the infiltrant material may have a material make up and/or performance properties that are different from that of a substrate used to provide the catalyst material for the initial sintering of the diamond body. For example, the substrate selected for sintering the diamond body may comprise a material make up that facilitates diamond bonding, but that may have poor erosion resistance and as a result not be well suited for an end-use application in a drill bit. In this case, the substrate selected at this stage for providing the source of the infiltrant may be selected from materials different from that of the sintering substrate, e.g., from materials capable of providing improved down hole properties such as erosion resistance when attached to a drill bit. Accordingly, it is to be understood that the substrate material selected as the infiltrant source may be different from the substrate material used to initially sinter the diamond body.

FIG. 4 illustrates the diamond body 32 at a stage when it is filled with the infiltrant material, wherein the diamond body is free standing. However, as mentioned above, it is to be understood that the diamond body 32 filled with the infiltrant material at this stage of processing may be in the form of a compact construction comprising a substrate attached thereto. The substrate may be attached during the HPHT process used to fill the diamond body with the infiltrant material. Alternatively, the substrate may be attached separately from the HPHT process used for filling, such as by a separate HPHT process, or by other attachment technique such as brazing or the like.

In addition to or in place of the replacement or infiltrant material, the diamond body may include another material disposed within the interstitial regions. Such other materials may include those that function to enhance the thermal properties of the diamond body and/or add compressive stress to the diamond in the diamond body. In an example embodiment such other materials may be non-solvent catalyst materials, and may include metallic materials having a high thermal conductivity such as copper, silver and the like. Such other materials may include metals, or metal alloys that may or may not include carbide forming elements such as titanium and the like.

In an example embodiment, such other material may be introduced in the diamond body during a HPHT process. It may be introduced as the only replacement or infiltrant material or it may be introduced in addition to one of the replacement or infiltrant materials mentioned above. In the event that the other material is used in addition to a replacement or infiltrant material mentioned earlier, both materials may be introduced into the diamond body during a single HPHT process. In such an embodiment, the other material may be selected to have a melting temperature that is lower than the replacement or infiltrant material such that it melts and infiltrates the diamond body ahead of the replacement material. Alternatively, the other material may be introduced into the diamond body in a separate step or independently from the replacement material.

In such an embodiment, the presence of the other material in the diamond body operates to provide one or more improved thermal property and/or add compressive stress to the diamond body, while the presence of the replacement or infiltrant material operates to improve toughness, strength, thermal stability and/or bond strength with a substrate. Ideally, the combined presence of the materials within the diamond body operate to provide an enhanced degree of diamond body performance while also facilitating the process of making the TSP construction.

If desired, an infiltrant aid may be used to enhance the process of introducing the replacement or infiltrant material into the diamond body. It has been discovered that the use of such an infiltrant aid may operate to improve the degree of replacement material infiltration within the diamond body. Additionally, the use of an infiltrant aid may reduce cracking and/or fracturing during HPHT processing. Materials useful as the infiltrant aid include those having a relatively low melting point and that may operate to reduce the melting temperature of the replacement or infiltrant material during the HPHT process. It is desired that the infiltrant aid be selected from materials that do not sacrifice or compromise desired performance properties of the TSP construction, e.g., thermal stability, attachment strength to the substrate, and the like.

Examples of useful infiltrant aids include materials such as Fe, Cu, Ni, combinations thereof, and any forms of alloys that operate to enhance infiltration. Additional materials include Cu, Ti and the like. In an example embodiment, wherein the replacement or infiltrant material is Co or other solvent metal catalyst, suitable infiltrant aids include Fe, Cu, Ni and combinations thereof. When combined with the infiltrant or replacement material, e.g., when the infiltrant is Co, the resulting alloy may be Co—Ni, Co—Ni, Co—Fe, Co—Ni—Fe, or any combination thereof. The infiltrant aid may be provided in the form of a powder, a green state part, or solid state part such as a foil or the like. The infiltrant aid may be present in the substrate as part of the substrate binder phase. The infiltrant aid or part comprising the same is positioned adjacent the diamond body for contacting the replacement material during HPHT processing.

Once the diamond body 32 has been filled with the desired infiltrant and/or other materials, a region of the diamond body may optionally be treated to remove the infiltrant material therefrom. Techniques useful for removing a portion of the infiltrant material from the diamond body includes the same ones described above for removing the catalyst material used to initially form the diamond body from the PCD material.

In an example embodiment, it the infiltrant material may be removed from a targeted region of the diamond body, e.g., extending a defined depth from one or more diamond body surfaces. These surfaces may include working and/or nonworking surfaces of the diamond body. In an example embodiment, the infiltrant material may be removed from the diamond body a depth of less than about 0.5 mm from the desired surface or surfaces, and preferably in the range of from about 0.05 to 0.6 mm. Ultimately, the specific depth of any removed infiltrant material will vary depending on the particular end-use application. Thus, the resulting TSP body may include a first region including the infiltrant material, and a second region that is substantially free of the infiltrant material.

As noted above, the sintered PCD body is treated to remove the catalyst material therefrom. In an example embodiment, it is desired that the TSP body have a thickness of about 1.5 mm or greater. It has been discovered that diamond bodies having a thickness of less than about 1.5 mm, once the catalyst material has been removed therefrom to form TSP, tend to fracture or otherwise crack when being attached to a substrate during HPHT processing. TSP bodies having a thickness of 1.5 mm or more have demonstrated improved strength and resistance to flexure during substrate attachment by HPHT processing, thereby permitting attachment without fracture. The TSP body may be initially formed having the desired thickness, or may be thinned using conventional methods after formation to the desired thickness.

In an example embodiment, TSP bodies useful for forming compact constructions have a thickness of greater than about 1.5 mm, preferably in the range of from about 1.5 to 2.5 mm, and in some embodiments in the range of from about 1.5 to 2 mm, or from about 2 to 2.5 mm. The exact thickness of the TSP body that resists cracking during subsequent processing may vary depending on a number of different factors, including the diameter of the TSP body or part being made. Generally, the larger the diameter of the TSP body the greater its desired thickness. Additionally, the minimum thickness for the TSP body will also depend on whether the interface between the TSP body and substrate is planar or nonplanar. Generally speaking, a minimum thickness of greater than about 1.5 mm is useful in construction embodiments comprising a nonplanar interface between the TSP body and substrate. This minimum thickness of the TSP body is measured before the TSP body is subjected to a second HPHT process for attachment to the substrate, and is measured at the thinnest point between opposed TSP body surfaces.

It is to be understood that the exact thickness of the TSP body will depend on a number of different factors such as the diameter of the diamond body, the size and volume content of the diamond grains in the diamond body, the HPHT processing conditions used to attached the diamond body to the substrate, the type of infiltrant material residing in the TSP body, and the nature of the substrate interface, e.g., whether planar or nonplanar.

Unwanted fracture of the TSP body, during HPHT attachment to the substrate, may be further avoided by using a material in the press cell that functions to better distribute loading across the TSP body or disk. In an example embodiment, such a material is loaded into the cell that is placed into the HPHT device, and that contains the TSP body and substrate. The material is positioned around the exposed surfaces of the TSP body and operates to more evenly distribute the press load along the surface of the TSP body during the HPHT process. It is helpful to provide a TSP body that has a diameter that is smaller than a diameter of the substrate, such that a gap exists between the TSP and the material which may be filled with the material during the HPHT attachment process.

In an example embodiment, the material used in the cell to distribute loading across the TPS body is a non-sintering material that does not infiltrate the TSP body and/or the substrate. In an example embodiment the non-sintering material has a high melting point, high decomposition temperature, good powder flowability, and low self-diffusion coefficient and does not react with either the diamond or the infiltrant material. In an example embodiment, the nonsintering material is selected from the group of materials including hBN, cBN, Si₃N₄, MN, and combinations thereof. In an example embodiment, the preferred material useful within the cell is hBN (hexagonal boron nitride).

In an example embodiment, the hBN may be provided as a homogenous volume within the cell, comprising hBN grains having a substantially similar average grain size. Alternatively, the hBN may be provided in the form of two or more layers within the cell, wherein each layer comprises hBN grains having a similar average size, and wherein the hBN grain sizes in the layers are different. Further still, the hBN may be provided in a single layer comprising a multi-modal distribution of hBN having two or more average grain sizes mixed together. In an example embodiment, it is desired that the hBN be provided in two layers, wherein a first layer comprises hBN grains having a relatively coarse grain size, and a second layer comprises hBN grains having a relatively fine grain size. In an example embodiment, the coarse hBN grains may have an average grain size of about 10 micrometers, and the fine hBN grains may have an average grain size of about 1 micrometer. As used herein, the term average is understood to represent the average of a distribution of the hBN grains within a selected grain volume.

In one embodiment, the non-sintering material is provided as an insulator layer in an enclosure assembly such as a can 132, as shown in FIG. 12. A substrate 112 and TSP body 114 are placed in the can 132 through a top opening 144, with the substrate 112 above the TSP body 114. The TSP body rests on an insulator layer 136 that prevents the TSP material from touching and reacting with the walls and floor of the can 132. In an exemplary embodiment, the insulator is in powder form. The TSP and substrate are pushed down into the can to cause the insulator 136 to flow up around the sides of the TSP body and the substrate. In an exemplary embodiment, the insulator material is a non-sintering, non-reacting material such as hexagonal boron nitride (hBN), cubic boron nitride (CBN), silicon nitride, an oxide, or a ceramic. The hBN is preferred for its good flowability. The insulator layer insulates the can from the TSP diamond and vice versa. The insulator layer also can reduce occurrences of cracking in the TSP body during the bonding process. It is understood that the use of an insulator material may be used to form any ultra hard material cutting element using any process. In particular, an insulator material may be used to attach a TSP material to a substrate using any method for bonding the TSP material to the substrate, e.g., with or without applying heat and a vacuum during the bonding process.

A disc 138 made from the same material as the can is placed on top of the substrate 112 in the can, as shown in FIG. 12, to form a top surface or lid on the can 132. After the insulator layer 136, TSP material 114, substrate 112, and disc 138 are placed into the can 132, and the TSP and substrate have been pushed down into the insulator, the top end 134a of the peripheral wall 134 of the can is folded over to retain these materials in the can 132. A layer or disc of braze material 140 is placed on top of the disc 138 and folded end 134a, whereby the folded end is sandwiched between the disc 138 and the braze material disc 140. In an exemplary embodiment, the folded portion overlaps the disc 138 along its entire periphery. Finally, a can cap or lid 142 is placed over the braze material to complete the can assembly 130. Optionally, the outer end 142a of the cap 142 is folded over as shown in FIG. 12 to further seal the can and prevent the braze material from leaking out of the can as it melts. The TSP and substrate are then subjected to an HPHT bonding process to bond the TSP to the substrate.

The TSP diamond body may be infiltrated and joined to the substrate using a two-stage or two-step HPHT process. TSP constructions are conventionally made using a single-step HPHT process operated at constant temperature and pressure. It has been discovered that the process of making TSP constructions by such single-step HPHT process oftentimes results in a TSP diamond body having a relatively low degree of infiltration, and a resulting reduced degree of desired performance properties.

In an example embodiment, TSP constructions may be made using a two-stage or two-step HPHT substrate rebonding or attachment process. In a first step, the diamond body and substrate are subjected to heat and pressure sufficient to bring the diamond body and substrate into the diamond stable region for a sufficient amount of time to ensure complete material infiltration. During this first step, the infiltrant material melts and is infiltrated into the diamond body. In an example embodiment, where the replacement material is Co, the first stage of HPHT processing may take place at a temperature in the range of from about 1350 to 1450° C., at a pressure in the range of from about 5,000 to 6.000 MPa, for 30 to 300 seconds.

During a second step of HPHT processing, the pressure is increased to provide the desired bonded attachment to the substrate and to provide the desired final performance properties of the TSP compact construction. In an example embodiment, where the replacement material is Co, the second stage of HPHT processing may take place at a temperature in the range of from about 1400 to 1500° C., at a pressure in the range of from about 5,500 to 6,500 MPa, for 30 to 300 seconds. While the pressure ranges described above between the first and second steps may be seen to have an overlapping range, it is to be understood that it is beneficial for a higher pressure to be used in the second stage relative to the first. TSP constructions made according to this two-stage HPHT processing technique display properties of improved replacement material infiltration and substrate attachment strength when compared to TSP constructions infiltrated and bonded using a single HPHT process condition, i.e., using constant temperature and constant pressure pressing.

In general regarding the TSP HPHT rebond process, it has been found from both a yield and properties perspective that it is beneficial to rebond at a higher pressure compared to the pressures used in sintering (to form the PCD body). Using higher pressures in rebonding gives better re-infiltration yields as the higher pressures facilitate movement of liquid cobalt through the porous TSP material. Rebonding at higher pressures than the sintering pressure has been found to give improved wear resistance in the product and also increases the intrinsic compressive stresses which improve impact performance.

In an example embodiment, it is desired that the second stage HPHT pressure be at least about 5 percent greater, preferably between about 5 to 50 percent greater, and more preferably between about 20 to 30 percent greater than the first stage HPHT pressure during rebonding.

FIG. 5 illustrates an example embodiment TSP compact construction 50 comprising the diamond body 52 attached to a desired substrate 54. As noted above, the substrate 54 may be attached to the diamond body 52 during the HPHT process that is used to introduce the replacement or infiltrant material into the diamond body. Alternatively, the substrate may be attached to the diamond body separately from introducing the infiltrant material by either HPHT process or by brazing, welding, or the like.

In an example embodiment, the substrate used to form the TSP compact construction is formed from a cermet material, such as that conventionally used to form a PCD compact. In a preferred embodiment, when the substrate is used as the source of the replacement material, the substrate is formed from a cermet, such as a WC, further comprising a binder material that is the infiltrant material used to fill the diamond body. Suitable binder materials include Group VIII metals of the Periodic table or alloys thereof, and/or Group IB metals of the Periodic table or alloys thereof, and/or other metallic materials.

One or both of the interfacing surfaces between the substrate and diamond body may be planar or nonplanar. A nonplanar interface between the diamond body and substrate is desirable to provide an increased degree of delamination resistance during use. The nonplanar surface of one or both of the diamond body and substrate may be symmetrical or asymmetrical.

An intermediate material or interlayer may be interposed between the substrate and the diamond body. The intermediate material may be formed from materials capable of forming a suitable attachment bond between both the diamond body and the substrate. Additionally, in the case where the diamond body-substrate interface is nonplanar, it is desired that the material useful for forming the intermediate layer (or interlayer) function as a manufacturing aid to reduce fracture and/or crack formation in the diamond body during HPHT processing.

In an embodiment comprising an interlayer disposed between the TSP body and the substrate, a desired nonplanar interface between the TSP body and substrate may be provided along only one of the TSP body or substrate interfacing surfaces. For example, the TSP body may comprise a nonplanar surface feature along the surface positioned adjacent the substrate, and the adjacent surface of the substrate may be planar, or visa versa. The interlayer, when provided in a powder or green state form, may be used to accommodate such differences between the adjacent TSP body and substrate interfacing surface features so that complementary nonplanar surface features on both the TSP body and substrate are not needed. Thus the interlayer may have a first surface that mates with or matches the inerface surface of the TSP body, and a second opposing surface that mates with or matches the interface surface of the substrate.

Suitable materials useful as the intermediate material or interlayer include those described above as being useful as the replacement material. Suitable intermediate materials may be selected from the group including ceramic materials, metallic materials, cermet materials, and mixtures thereof. Examples of such materials include WC powders, WC powders mixed with one or more Group VIII materials, e.g., Co, and transition powders including a constituent of both the diamond body and the substrate, e.g., where a WC substrate is used, the transition powder may comprise WC/M powder (where M is a metal constituent of the substrate such as Co) mixed with diamond grains. The interlayer may be provided in the form of a powder volume, a green-state volume, or a presintered body.

FIG. 6 illustrates an embodiment of a TSP construction 60 comprising a diamond body 62 comprising a TSP region 64 and a PCD region 66. The TSP region is substantially free of the catalyst material that was used to initially form the polycrystalline diamond matrix within it. The TSP region may or may not include a replacement or infiltrant material, such as one described above, disposed within a population of its interstitial regions. The TSP region may comprise all of the features of the TSP diamond bodies described above. The PCD region comprises the catalyst material that was used to initially sinter it. The TSP and PCD regions of the diamond body may have different diamond grain sizes and/or have different diamond volume contents depending on the particular end-use application.

The TSP construction is in the form of a compact where the diamond body 62 is attached to a substrate 68. The TSP region 64 extends from a top portion of the diamond body 62 to the PCD region 66, and the PCD region 66 is interposed between the TSP region 64 on one side and the substrate 68 on an opposite side. The interface between the PCD region and the substrate may be planar or nonplanar, and in a preferred embodiment is nonplanar to provide an enhanced degree of attachment strength between the substrate and diamond body to resist unwanted delamination during use in a wear or cutting operation.

A feature of the TSP construction illustrated in FIG. 6 is that the TSP region of the diamond body is formed separately from the PCD region. Specifically, the TSP region may be formed according to the methods disclosed above for forming a TSP diamond body. The resulting TSP body, with or without an infiltrant material, is subsequently attached to preexisting PCD compact construction comprising a PCD diamond body that is attached to a substrate.

In a preferred embodiment, the interface between the PCD body and the substrate is nonplanar. Thus, attaching the TSP diamond body to the existing PCD compact enables formation of a TSP construction comprising a nonplanar interface between the diamond body and substrate to provide an enhanced degree of resistance against delamination without the manufacturing challenges that typically accompany attaching a TSP diamond body to a substrate having a nonplanar interface.

The TSP diamond body is attached to the existing PCD compact by HPHT process. In an example embodiment, means may be used to facilitate attachment of the TSP diamond body to the underlying PCD diamond body. Such means may include an intermediate material or interlayer formed from a material that facilitates bonding between the adjacent diamond bodies. Such material may be provided in powder, green-state, or solid form. The material may be selected from the group including carbide formers. In an example embodiment, a carbide ring is disposed around the TSP diamond body that is stacked onto a top surface of the PCD diamond body. In another embodiment, a metal foil is interposed between the TSP diamond body and PCD diamond body to facilitate attachment therebetween.

TSP constructions comprising the above-identified features and made in the manner described above display marked improvements in desired performance properties such as thermal stability, toughness, impact strength, and substrate attachment/bond strength and resulting resistance to delamination when compared to conventional TSP constructions. Additionally, the methods described above for making such TSP constructions facilitate to improve the manufacturing process by reducing the formation of cracks or fractures within the TSP diamond body during the HPHT attachment process, thereby improving TSP construction yield.

TSP constructions according to embodiments of the present disclosure may be used to form wear and/or cutting elements in a number of different applications such as the automotive industry, the oil and gas industry, the aerospace industry, the nuclear industry, and the transportation industry to name a few. In exemplary embodiments, TSP constructions are well suited for use as wear and/or cutting elements that are used in the oil and gas industry in such application as on drill bits used for drilling subterranean formations.

FIG. 7 illustrates an embodiment of a TSP diamond compact construction provided in the form of an insert 70 used in a wear or cutting application in a roller cone drill bit or percussion or hammer drill bit used for subterranean drilling. For example, such inserts 70 may be formed from blanks comprising a substrate 72 formed from one or more of the substrate materials 73 disclosed above, and a diamond body 74 having a working surface 76. The blanks are pressed or machined to the desired shape of a roller cone rock bit insert.

Although the insert in FIG. 7 is illustrated having a generally cylindrical configuration with a rounded or radiused working surface, it is to be understood that inserts formed from TSP constructions according to embodiments of this disclosure configured other than as illustrated and such alternative configurations are understood to be within the scope of this invention.

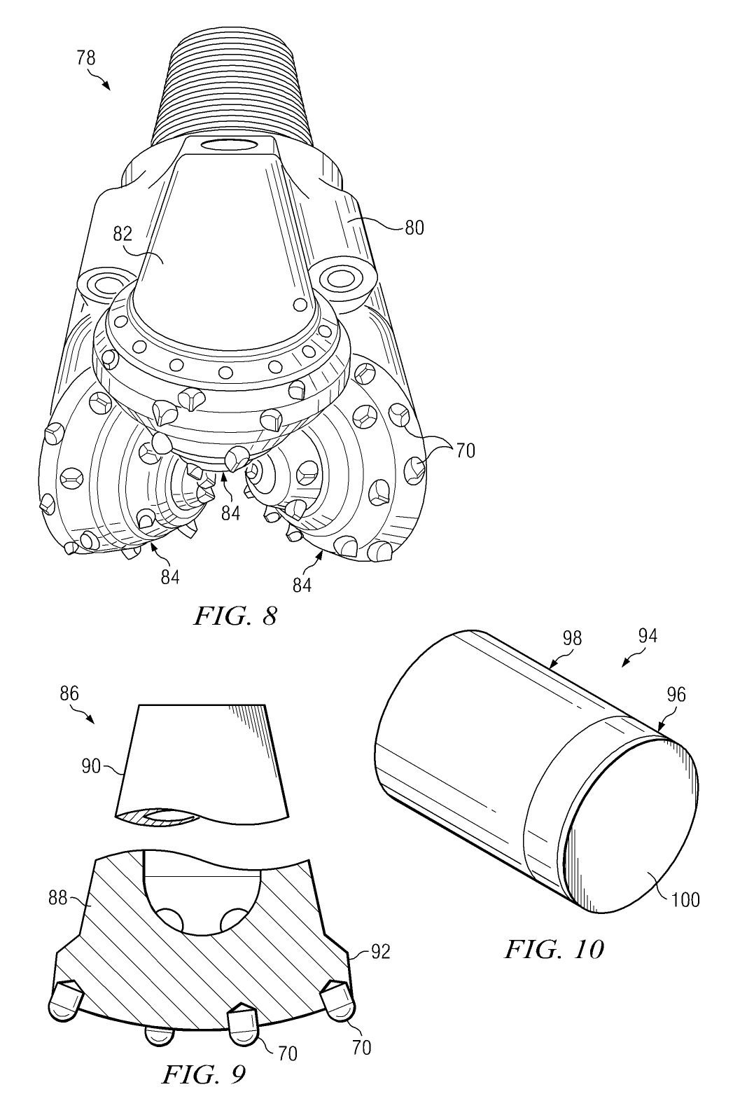

FIG. 8 illustrates a rotary or roller cone drill bit in the form of a rock bit 78 comprising a number of the wear or cutting inserts 70 disclosed above and illustrated in FIG. 7. The rock bit 78 comprises a body 80 having three legs 82, and a roller cutter cone 84 mounted on a lower end of each leg. The inserts 70 may be fabricated according to the method described above. The inserts 70 are provided in the surfaces of each cutter cone 84 for bearing on a rock formation being drilled.

FIG. 9 illustrates the inserts 70 described above as used with a percussion or hammer bit 86. The hammer bit comprises a hollow steel body 88 having a threaded pin 90 on an end of the body for assembling the bit onto a drill string (not shown) for drilling oil wells and the like. A plurality of the inserts 70 is provided in the surface of a head 92 of the body 88 for bearing on the subterranean formation being drilled.

FIG. 10 illustrates a TSP construction compact embodied in the form of a shear cutter 94 used, for example, with a drag bit for drilling subterranean formations. The shear cutter 94 comprises a diamond body 96 attached to a cutter substrate 98. The diamond body 96 includes a working or cutting surface 100.

Although the shear cutter in FIG. 10 is illustrated having a generally cylindrical configuration with a flat working surface that is disposed perpendicular to an axis running through the shear cutter, it is to be understood that shear cutters formed from TSP constructions according to embodiments of this disclosure may be configured other than as illustrated and such alternative configurations are understood to be within the scope of this invention.

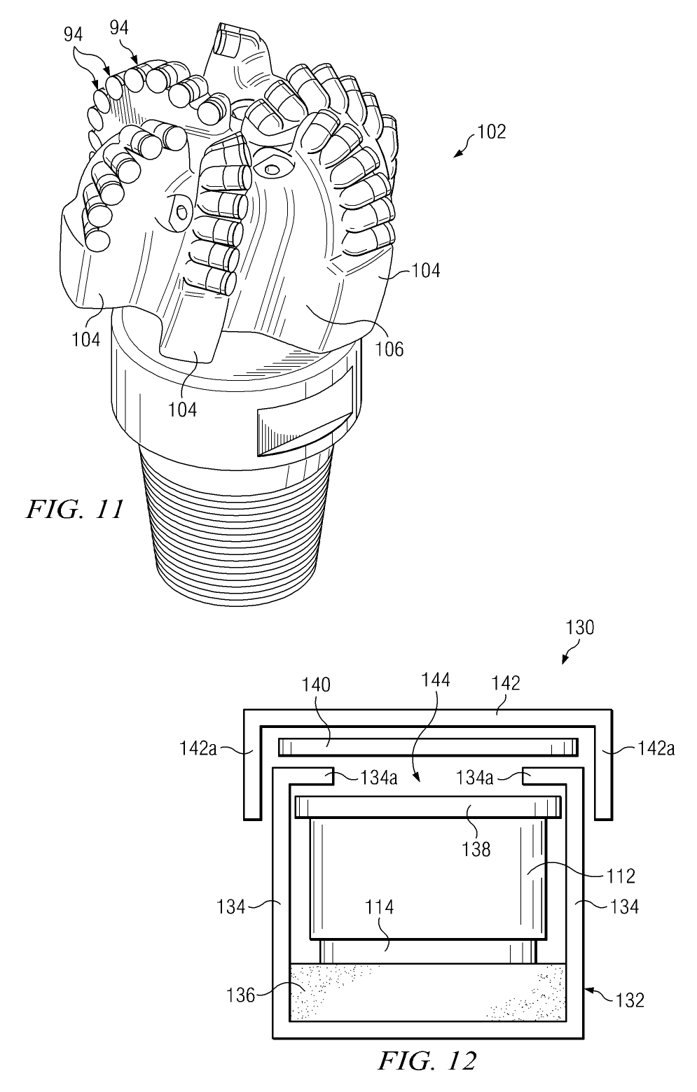

FIG. 11 illustrates a drag bit 102 comprising a plurality of the shear cutters 94 described above and illustrated in FIG. 10. The shear cutters are each attached to blades 104 that each extend from a head 106 of the drag bit for cutting against the subterranean formation being drilled.

Other modifications and variations of TSP diamond bodies, constructions, compacts, and methods of making the same according to the principles of this invention will be apparent to those skilled in the art. It is, therefore, to be understood that within the scope of the appended claims, this invention may be practiced otherwise than as specifically described.

What is claimed is:

1. A polycrystalline diamond construction comprising:
a diamond body having a material microstructure comprising a matrix phase of bonded together diamond crystals formed at high pressure-high temperature conditions in the presence of a catalyst material, and interstitial regions disposed between the diamond crystals, wherein the interstitial regions within the diamond body are substantially free of the catalyst material, wherein the diamond body comprises a replacement material disposed within the interstitial regions, and wherein the diamond body has a thickness greater than about 1.5 mm; and
a substrate joined with the diamond body;
wherein the diamond body and substrate include interfacing surfaces with nonplanar surface features that complement one another, and wherein the substrate is in direct contact with the diamond body.

2. The construction as recited in claim 1 wherein the diamond body thickness is in the range of from about 1.5 mm to 2.5 mm.

3. The construction as recited in claim 1 including a non-solvent catalyst material disposed within the diamond body, wherein the non-solvent catalyst material is different from the replacement material.

4. The construction as recited in claim 3 wherein the non-solvent catalyst material is selected from the group consisting of Si, Ti, Cu, low melting temperature materials, and alloys thereof.

5. The construction as recited in claim 1 including an infiltrant aid disposed within the diamond body, wherein the infiltrant aid is selected from the group of materials consisting of Fe, Cu, Ni, and combinations thereof

6. The construction as recited in claim 1 wherein the diamond body comprises:
a first region comprising diamond grains having a first average size, and having a first average diamond volume content; and
a second region comprising diamond grains having a second average size, and having a second average diamond volume content, wherein the first average diamond volume content is different from the second average diamond volume content.

7. The construction as recited in claim 6 wherein the difference between the first and second average diamond volume content is greater than about one percent.

8. The construction as recited in claim 6 wherein the first average diamond volume content is greater than the second average diamond volume content.

9. The construction as recited in claim 6 wherein the first average size is in the range of from about 2 to 18 microns, and the first average diamond volume content is greater than about 90 percent, and wherein the second average size is in the range of from about 15 to 35 microns, and the second average diamond volume content is greater than about 80 percent.

10. The construction as recited in claim 6 wherein the second region is positioned adjacent the substrate.

11. The construction as recited in claim 6 wherein the first region has a thickness greater than about 0.5 mm, and the second region has a thickness greater than about 1 mm.

12. A bit for drilling subterranean formations comprising a body and a number of cutting elements attached to the body, wherein the cutting elements comprise the construction of claim 1.

13. A polycrystalline diamond construction comprising:
a diamond body having a material microstructure comprising a matrix phase of bonded together diamond crystals formed at high pressure-high temperature conditions in the presence of a catalyst material, and interstitial regions disposed between the diamond crystals, wherein the interstitial regions within the diamond body are substantially free of the catalyst material, wherein the diamond body comprises a replacement material disposed within the interstitial regions, and wherein the diamond body comprises:
a first region comprising diamond grains having a first average size, and having a first average diamond volume content; and
a second region comprising diamond grains having a second average size, and having a second average diamond volume content, wherein the first average diamond volume content is different from the second average diamond volume content;
a substrate joined with the diamond body.

14. The polycrystalline diamond construction of claim 13, wherein the replacement material bonds the diamond body to the substrate.

15. The construction as recited in claim 13 wherein the difference between the first and second average diamond volume content is greater than about 1 percent.

16. The construction as recited in claim 13 wherein the first average diamond grain size is less than the second average diamond grain size, and wherein the first average diamond volume content is greater than the second average diamond volume content.

17. The construction as recited in claim 13 wherein an interface between the diamond body and the substrate is nonplanar.

18. The construction as recited in claim 17 further comprising an interlayer interposed between the diamond body and the substrate, wherein the interlayer comprises a constituent of the substrate and exists independently of the substrate.

19. The construction as recited in claim 18 wherein both the diamond body and the substrate include a nonplanar surface features along surfaces positioned adjacent one another.

20. The construction as recited in claim 18 wherein the interlayer comprises diamond grains.

21. The construction as recited in claim 13 wherein the diamond body has an thickness of greater than about 1.5 mm.

22. A polycrystalline diamond construction comprising:
a diamond body having a material microstructure comprising a matrix phase of bonded together diamond crystals and interstitial regions disposed between the diamond crystals, wherein the diamond body comprises:
a first diamond region, wherein the matrix phase of bonded together diamond crystals in the first diamond region are formed during a first high pressure-high temperature process, and wherein the first diamond region is substantially free of a catalyst material used during the first high pressure-high temperature process; and
a second diamond region, wherein the matrix phase of bonded together diamond crystals in the second diamond region are formed, during a second high pressure-high temperature process, and wherein the second diamond region includes a catalyst material used during the second high pressure-high temperature process;
a substrate joined with the diamond body.

23. The construction as recited in claim 22 further comprising an intermediate layer interposed between the first diamond region and the second diamond region.

24. The construction as recited in claim 23 wherein the first diamond region includes an infiltrant material disposed within some population of the interstitial regions.

25. The construction as recited in claim 22 wherein an interfacing surface between the substrate and diamond body is nonplanar.

26. The construction as recited in claim 22 wherein the diamond body and substrate are joined together during the second high pressure-high temperature process, and the first diamond region is attached to the second diamond region during a third high pressure-high temperature process.

27. A bit for drilling subterranean formations comprising a body and a number of cutting elements attached to the body, wherein the cutting elements comprise the construction of claim 22.

28. The construction as recited in claim 22 wherein the first diamond region has a thickness of greater than about 1.5 mm.

29. The construction as recited in claim 22 wherein the first diamond region has a thickness in the range of from about 1.5 mm to 2.5 mm.

30. A method of making a thermally stable diamond construction comprising the steps of:
forming a polycrystalline diamond body at high pressure-high temperature conditions in the presence of a catalyst material to form a matrix phase of bonded together diamond crystals;
removing the catalyst material from the polycrystalline diamond body to form a thermally stable diamond body;
placing the thermally stable diamond body adjacent a substrate, wherein the thermally stable diamond body and substrate are disposed within a pressure cell, wherein the pressure cell includes hBN surrounding exposed surfaces of the thermally stable diamond body; and
subjecting the pressure cell to high pressure-high temperature conditions to bond the thermally stable diamond body to the substrate.

31. The method as recited in claim 30 further comprising the step of treating the thermally stable diamond body to introduce an infiltrant material therein, the infiltrant material occupying a population of interstitial regions disposed between the bonded together diamond crystals.

32. The method as recited in claim 30 wherein the thermally stable diamond body has a thickness of greater than about 1.5 mm.

33. The method as recited in claim 30 wherein the thermally stable diamond body has a thickness in the range of from about 1.5 mm to 2.5 mm.

34. The method as recited in claim 30 further comprising placing an infiltration aid between the thermally stable diamond body and substrate before the step of subjecting, wherein the infiltration aid facilitates infiltration of an infiltrant material into the thermally stable diamond body during the subjecting.

35. The method as recited in claim 30 wherein an interfacing surface between the substrate and thermally stable diamond body is nonplanar.

36. The method as recited in claim 30 further comprising placing an intermediate material between the thermally stable diamond body and the substrate before the step of subjecting.

37. The method as recited in claim 30 wherein the pressure used during the step of subjecting is greater than the pressure used during the step of forming.

38. The method as recited in claim 37, wherein the pressure used during the step of subjecting is at least 5 percent greater than the pressure used during the step of forming.

39. The method as recited in claim 30 wherein the thermally stable diamond body further comprises:
a first region comprising diamond grains having a first average size, and having a first diamond volume content; and
a second region comprising diamond grains having a second average size, and having a second diamond volume content, wherein the first average diamond grain size is less than the second average diamond grain size, and wherein the first average diamond volume content is greater than the second average diamond volume content.

40. The method as recited in claim 30 wherein the hBN is provided having two or more grain sizes.

41. The method as recited in claim 40 wherein the different hBN grain sizes are separate from one another and provided in two or more respective layers.

42. A method of making a thermally stable diamond construction comprising the steps of:
forming a polycrystalline diamond body at high pressure-high temperature conditions in the presence of a catalyst material to form a matrix phase of bonded together diamond crystals;
removing the catalyst material from the polycrystalline diamond body to form a thermally stable diamond body;
placing the thermally stable diamond body adjacent a substrate, wherein the thermally stable diamond body and substrate are disposed within a pressure cell;
subjecting the pressure cell to a first high pressure-high temperature condition in the diamond stable region to cause an infiltrant material to melt and infiltrate into the thermally stable diamond body; and
subjecting the pressure cell to a second high pressure-high temperature condition to cause the infiltrated thermally stable diamond body to bond to the substrate, wherein the second high pressure-high temperature condition is operated at a higher pressure than the first high pressure-high temperature condition.

43. The method as recited in claim 42 wherein the thermally stable diamond body has a thickness of greater than about 1.5 mm.

44. The method as recited in claim 43 wherein the thermally stable diamond body has a thickness in the range of from about 1.5 mm to 2.5 mm.

45. The method as recited in claim 42 further comprising placing an infiltration aid between the thermally stable diamond body and substrate before the step of subjecting, wherein the infiltration aid facilitates infiltration of the infiltrant into the thermally stable diamond body during the step of subjecting the pressure cell to a first high pressure-high temperature condition.

46. The method as recited in claim 42 wherein an interfacing surface between the substrate and thermally stable diamond body is nonplanar.

47. The method as recited in claim 42 further comprising placing an intermediate material between the thermally stable diamond body and the substrate before the step of subjecting the pressure cell to a first high pressure-high temperature condition.

48. The method as recited in claim 42 wherein the thermally stable diamond body further comprises:
a first region comprising diamond grains having a first average size, and having a first diamond volume content; and
a second region comprising diamond grains having a second average size, and having a second diamond volume content, wherein the first average diamond grain size is less than the second average diamond grain size, and wherein the first average diamond volume content is greater than the second average diamond volume content.

49. The method as recited in claim 42 wherein the second high pressure-high temperature pressure is at least about 5 percent greater than the first high pressure-high temperature pressure condition.

50. The method as recited in claim 42 wherein the second high pressure-high temperature pressure is between about 5 to 50 percent greater than the first high pressure-high temperature pressure condition.

51. The method as recited in claim 42 wherein the second high pressure-high temperature pressure is between about 20 to 30 percent greater than the first high pressure-high temperature pressure condition.

52. A method of making a thermally stable diamond construction comprising the steps of:
forming a first polycrystalline diamond body at high pressure-high temperature conditions in the presence of a catalyst material to form a matrix phase of bonded together diamond crystals;
removing the catalyst material from the first polycrystalline diamond body to form a thermally stable diamond body;
placing the thermally stable diamond body adjacent a polycrystalline diamond compact comprising a second polycrystalline diamond body attached to a substrate to form an assembly; and
subjecting the assembly to a high pressure-high temperature condition to bond the thermally stable diamond body to the compact.

53. The method as recited in claim 52 further comprising the step of treating the thermally stable diamond body to introduce an infiltrant material therein, the infiltrant material occupying only a partial population of interstitial regions disposed between the bonded together diamond crystals.

54. The method as recited in claim 52 wherein the thermally stable diamond body has a thickness of greater than about 0.5 mm.

55. The method as recited in claim 54 wherein the second polycrystalline diamond body has a thickness of greater than about 1 mm.

56. The method as recited in claim 52 wherein an interfacing surface between the substrate and the second polycrystalline diamond body is nonplanar.

57. The method as recited in claim 52 further comprising placing an intermediate material between the thermally stable diamond body and the second polycrystalline diamond body.

58. The method as recited in claim 57 wherein during the step of subjecting, a constituent from the intermediate material infiltrates into the thermally stable diamond body.

59. The method as recited in claim 52 wherein the thermally stable diamond body further comprises:
a first region comprising diamond grains having a first average size, and having a first average diamond volume content; and
a second region comprising diamond grains having a second average size, and having a second average diamond volume content, wherein the first average diamond grain size is less than the second average diamond grain size, and wherein the first average diamond volume content is greater than the second average diamond volume content.

60. The method as recited in claim 52 wherein the pressure used during the step of subjecting is greater than the pressure used during the step of forming.

61. The method as recited in claim 52, wherein the pressure used during the step of subjecting is at least 5 percent greater than the pressure used during the step of forming.

62. The construction as recited in claim 21 wherein the diamond body thickness is in the range of from about 1.5 mm to 2.5 mm.
